(19) United States
(12) Patent Application Publication
(10) Pub. No.: US 2003/0048469 A1
(43) Pub. Date: Mar. 13, 2003

(54) System and method for voice status messaging for a printer

(76) Inventor: Gary E. Hanson, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/949,308

(22) Filed: Sep. 7, 2001

(51) Int. Cl. G06F 3/12; G06F 13/00; G06F 11/30; G06F 17/28

(52) U.S. Cl. 358/1.14; 710/19

(57) ABSTRACT

A printer status monitor comprises a status message monitor configured for audibly reporting voice messages regarding a status of a printer and at least one sensor configured for identifying the status of the at least one function of a printer. A method for reporting a printer status comprises sensing at least one feature of a printer and audibly reporting a status of the at least one feature of the printer with a voice message.

### THE FIELD OF THE INVENTION

The present invention relates to printers, and in particular, to status monitors of printers.

### BACKGROUND OF THE INVENTION

Conventional laser printers and inkjet printers typically include a control panel. The control panel usually includes a liquid crystal display (LCD) that displays textual messages and/or indicator lamps and icons that represent the status of different features of the printer. The control panel also commonly displays a menu of features that can be selected or deselected. Alphanumeric keys, directional arrow keys, and/or switch buttons on the control panel are used to navigate the menu on the control panel and operate the printer.

Conventional control panels are a relatively expensive component of printers. Moreover, to users unfamiliar with computers and printers, these conventional control panels can be rather confusing. The icons, symbols, and textual messages that identify the status of features tend to be rather cryptic.

On the other hand, a whole class of users exists that can understand the display, but have trouble reading the control panel display because of poor eyesight. Finally, for those individuals that are blind, a conventional control panel with a visual display is of no use at all.

The limited nature of these control panels also affects a user's ability to effectively troubleshoot a printer error. The troubleshooting guide available on a control panel of the printer typically carries only a small portion of the complete maintenance information. More complete information is not commonly included because of the limited display of the control panel. The troubleshooting guide can alternatively be located remotely in user's manual, stored in memory of a personal computer, and/or be available at a web site of the manufacturer or retailer of the printer.

For these reasons, conventional control panels have not yet yielded an optimal combination of performance, convenience and cost.

### SUMMARY OF THE INVENTION

A printer status monitor of the present invention comprises a status message monitor configured for audibly reporting voice messages regarding a status of at least one function of a printer and at least one sensor configured for identifying the status of the at least one function of a printer.

A method of the present invention for reporting a printer status comprises sensing at least one feature of a printer and audibly reporting a status of the at least one feature of the printer with a voice message.

### BRIEF DESCRIPTION OF THE DRAWINGS

FIG. 1 is a perspective view of a printer with voice status messaging, according to one embodiment of the present invention.

FIG. 2 is a block diagram of a voice status message monitor of a printer, according to one embodiment of the present invention.

FIG. 3 is a flow diagram of a method of voice status messaging for a printer, according to one embodiment of the present invention.

FIG. 4 is a block diagram of a custom user interface of a voice status messaging system, according to one embodiment of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the present invention may be implemented in hardware via a microprocessor, programmable logic, or state machine, in firmware, or in software within a given device. Components of the present invention may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

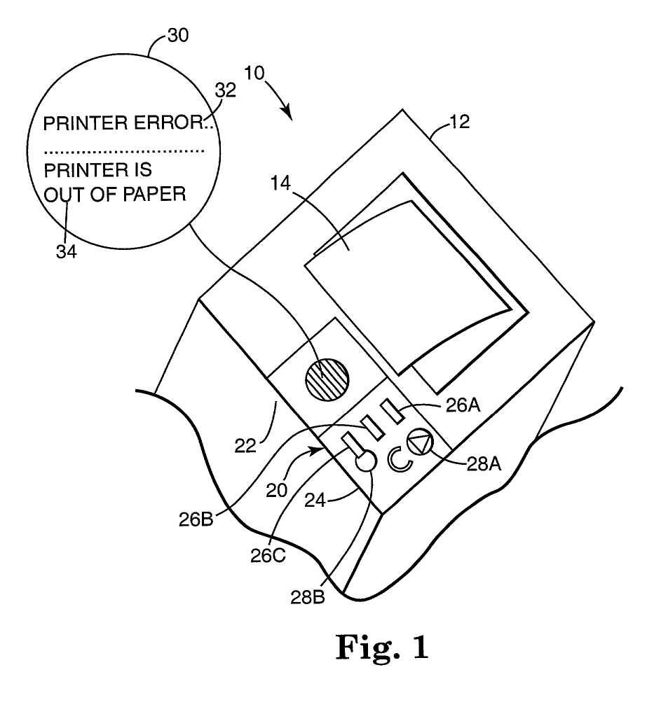

As shown in FIG. 1, system 10 includes a printer 12 for printing images on paper 14. Printer 12 includes user interface 20 having speaker 22 and control panel 24 with status lights 26 and keypad switch buttons 28. Speaker 22 comprises a conventional acoustic speaker or acoustic transducer that emits audible voice status message(s) 30 regarding the status of a function or feature of printer 12. As shown in FIG. 1, voice status message 30 reports to a nearby user: “PRINTER . . . PRINTER IS OUT OF PAPER”. Voice status message 30 preferably includes alert component 32, such as “PRINTER ERROR,” to catch the attention of the user followed by substantive message 34, such as “PRINTER IS OUT OF PAPER,” that informs the user of the actual malfunction. Voice status message 30 optionally includes an appropriate response to correct or maintain the printer. As will be later described in further detail, this additional response information and/or additional error information is obtained in additional audible voice status messages 30.

Status lights 26 of user interface 20 preferably include one or more light emitting diodes (LEDs) having an lit/unlit capability for identifying a status of the most basic functions of printer 12. For example, printer 12 preferably includes three status lights including message status light 26A, data transmission light 26B, and readiness light 26C. Data transmission light 26B informs the user that data is being transmitted to printer 12 while readiness light 26C informs the user that printer 12 is in standby mode or is ready to print. Finally, message status light 26A informs the user that printer 12 needs maintenance or service on a function of printer 12 and has a voice status message 30 regarding that function. Keypad button switches 28A and 28B provide on/off control for features corresponding to each status light. Accordingly, upon pressing message status button 28A, printer 12 audibly reports voice status message. Keypad button switch 28B controls whether printer is in a ready or standby state in association with readiness status light 26A.

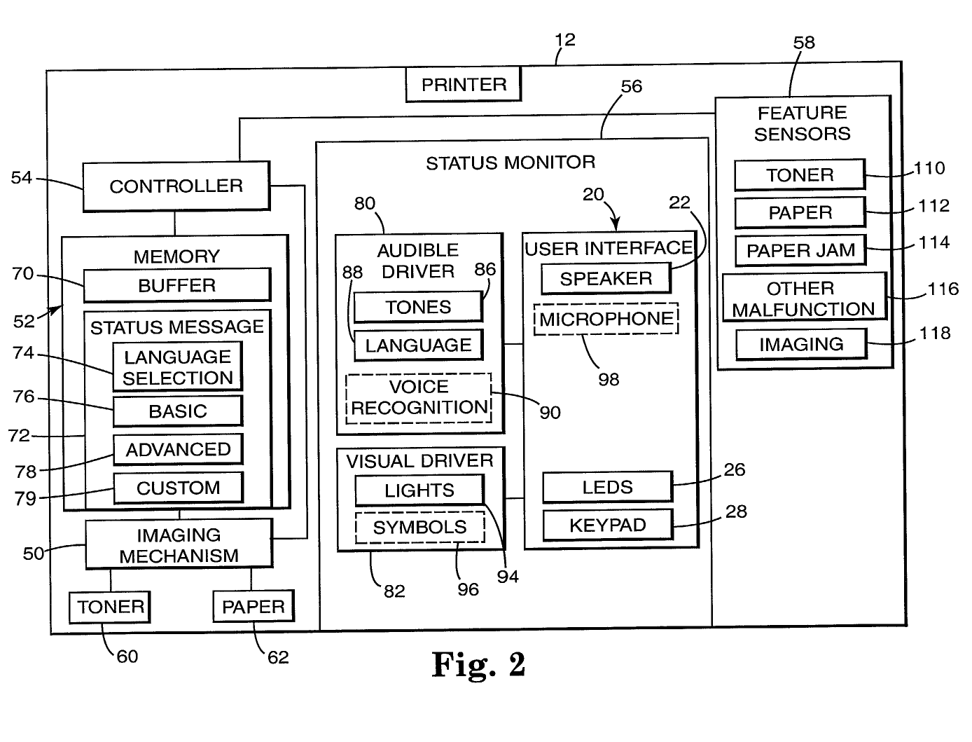

As shown in FIG. 2, printer 12 includes imaging mechanism 50, memory 52,controller 54, status monitor 56, and feature sensors 58. Memory 52 further comprises buffer 70 and status message module 72 including language base 74, basic function set 76, advanced function set 78, and custom voice status messages 79.

Imaging mechanism 50 typically includes a toner cartridge or other supply for holding toner 60 as well as optical photo sensors, rollers, platens, etc. for producing a printed image on paper 62. Imaging mechanism 50 can include components suitable for laser printing, inkjet printing, dot matrix printing, thermal printing, and other common printing methods.

Buffer of memory 52 stores a digital representation of the image to be printed on paper 62. In particular, buffer 70 receives an image file from a computer or other source and holds those images to be printed on paper 62 in a format suitably corresponding to the printing method.

Status message module 72 of memory 52 contains all voice status messages 30 that are emitted by printer 12 that correspond to the status of all the functions and features of printer 12. Status message module 72 includes language selection base 74 to permit voice status messages 30 from status message module 72 to be presented in virtually any language such as English, French, German, Spanish, etc. as well as other languages. Language selection base 74 permits voice status messaging feature of printer 12 to be localized for virtually any cultural, ethnic, and/or geographical environment. Finally, to conserve memory 52, each voice status messages 30 optionally can be expressed as one, two, or three word keywords instead of longer messages that repeat common words.

Basic function set 76 causes voice status messages 30 from status message module 72 to be presented at a basic level for novice users while advanced function set 78 causes voice status messages 30 of status message module 72 to be presented at a more detailed level for advanced users capable of responding to highly technical information. Finally, custom messages set 79 is optionally included and comprises recorded voice messages containing the user's actual voice so the user hears their own voice when printer 12 reports voice status message 30.

Controller 54 includes hardware, software, firmware or combination of these. In one preferred embodiment, controller 54 includes a microprocessor based system capable of performing a sequence and logic operations. The controller optionally includes an embedded web server for facilitating network communications including Internet communications, intranet communications, and other network communications. Controller 54 is in communication with imaging mechanism 50, memory 52, status monitor 56, and features sensor 58 for coordinating operation and functioning of those components of printer 12.

Status monitor 56 of printer 12 comprises user interface 20 with speaker 22, status lights 26 and keypad button switches 28. Status monitor 56 further comprises audible driver 80 and visual driver 82.

User interface 20 optionally includes microphone 98 for implementing voice recognition capability and/or recording a user's custom voice messages 80. Microphone 98 receives speech from a user near printer 12 for entry into voice recognition function 90 of audible driver 80.

Audible driver 80 further comprises tones function 86, language function 88, and optional voice recognition function 90. Finally, visual driver 82 includes status lights function 94 and optional symbols function 96. Tones function 86 includes a plurality of tones for identifying various alert states of printer 12. Language function 88 selects appropriate status messages 30 from status message module 72 of memory 52 and delivers voice status messages 30 audibly through speaker 22. Status lights function 94 of visual driver 82 support the operation of status lights 26 of user interface 20 in cooperation with button switches 26.

Feature sensors 58 track all of the serviceable functions and features of printer 12 so that upon a user receiving audible status message 30, the user can respond by performing maintenance on printer 30 or seeking professional service on printer 12. Feature sensors 58 include, but are not limited to, sensors for the following features and functions of printer 12: toner 110, paper 112, paper jam 114, general malfunction 116, and imaging 118. Other features and functions include, but are not limited to, photosensors, transfer drums, transfer belts, various color toner supplies, lasers, optical photoreceptor belts, etc. Feature sensors 58 are in communication with status monitor 56 via controller 54.

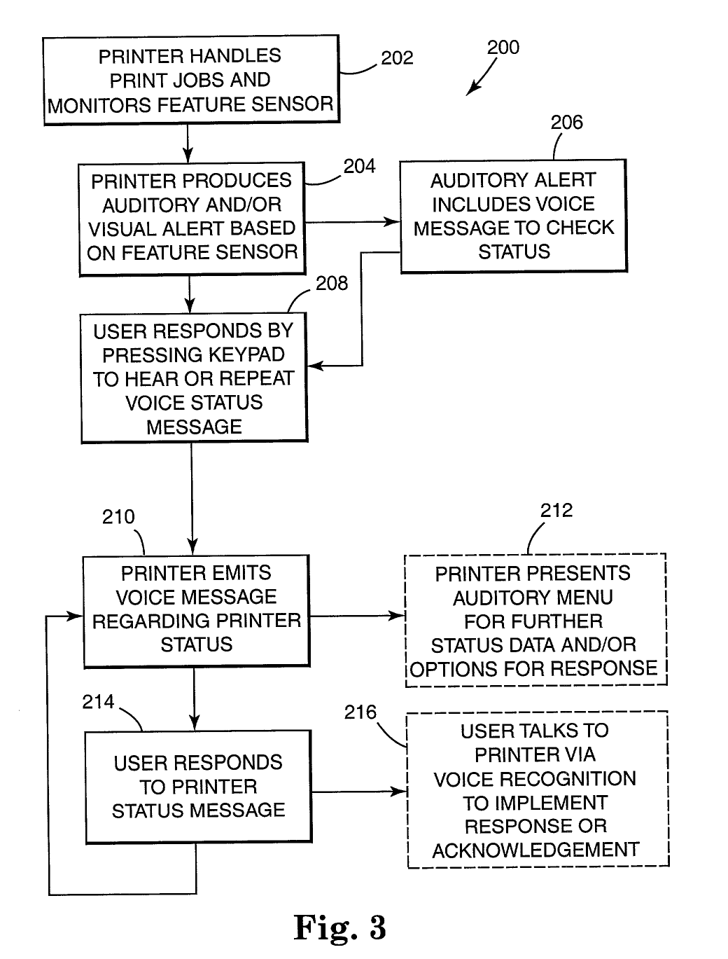

As shown in FIG. 3, printer 12 is used in method 200 of the present invention. In first step 202 of method 200, printer 12 handles print jobs and monitors feature sensors 58. Printer 12 commonly operates for long periods of time in first step 202 in which a user makes multiple printer requests and printer 12 complies with each request without error by printing the print job. While printer 12 operates in this state, features sensors 58 continually sense the state of the operating features and function of printer 12. However, occasionally printer 12 will experience a printer jam, run out of paper, run out of toner, or experience other malfunctions. In these cases, the user must be alerted to the situation.

Accordingly, in the next step 204 of method 200, printer 12 produces an auditory and/or visual alert based on triggering of one of feature sensors 58 (step 204). A visual alert includes a blinking message status light 26A while an auditory alert includes a beeping sound or other alert tone obtained from tones function 86 of auditory driver. Several different alert tones optionally are used, with each tone corresponding to a different error of printer 12.

In one aspect of the invention, the auditory alert in step 204 comprises voice status message 30 alerting the user to check the status of printer 12 (step 206). For example, the alert can include voice status message 30 such as “CHECK PRINTER”, “SERVICE PRINTER”, or “PRINTER ERROR”. In this arrangement the voice-based auditory alert is immediately followed by step 210 in which printer 12 emits a more detailed voice status message 30 regarding the status of printer 12. At the same time, message status light 26A is lit or blinks to provide an ongoing indication of the presence of voice status message 30.

In response to the alert in step 204, the user responds by pressing the keypad button switch 28A corresponding to message status light 26A on printer 12 to hear voice status message 30 for the first time, to repeat voice status message 30, and/or to information in addition to voice status message 30 (step 208). The next step 214 includes user responding to the voice status message 30, which is optionally followed by repeating step 210 in which printer 12 emits a further voice status message 30 regarding the status of printer 12.

In the event that status monitor 56 produces multiple status messages 30, then after the first voice status message 30, status monitor 56 optionally emits an indication of further information, such as “MORE MESSAGES”. Subsequent presses of message status button 28A result in printer 12 audibly reporting the additional voice status messages 30. Multiple voice status messages 30 are preferably audibly reported in decreasing order of significance.

Method 200 includes optional step 212 (following step 210) in which printer 12 presents a listing or menu for further status data and/or options for response to printer 12. For example, printer 12 occasionally experiences a paper jam. In step 212, menu recites voice status message 30 that identifies a sequence of printer areas of printer 12 to be checked to find the source of the paper jam, such as FIRST CHECK PAPER TRAY, SECOND CHECK DRUM, THIRD CHECK OUTPUT ROLLER, etc.

In another example, printer 12 can prompt the user with voice status message 30 to perform a routine maintenance operation. In this case, step 212 includes printer 12 audibly reporting steps for the user to take, such as CLEAN PLATEN, CLEAN IMAGING SURFACE, REPLACE TONER CARTRIDGE, PERFORM PRINTING ALIGNMENT TEST, etc. Subsequent presses of keypad button switch 28A produces audibly reporting of additional maintenance information.

In addition, optional step 216 of method 200 can follow step 214 and includes user talking to printer 12 (via voice recognition capability) to implement a response or acknowledgement to the voice message status of printer 12. In this arrangement, the user asks printer 12 certain questions, preferably using established maintenance keywords, to operate printer 12 and/or determine further information regarding the status of printer 12. For example, a user could tell printer 12, “GO OFF LINE”. In response, printer 12 would go into a standby mode. Alternatively, printer 12 could emit an alert and status message such as TONER IS LOW in which voice status message 30 keeps sounding until the user acknowledges voice status message 30 by replying with the spoken word “OKAY”.

Printer 12 also can audibly report successful operations. For example, upon completion of a printing job, printer 12 can report that a print job is completed with audible voice status message 30, such as “PRINT JOB IS COMPLETE”. Likewise, printer 12 can report which print job is being completed or started with audible voice status message 30, such as “GARY'S ESSAY HAS BEEN PRINTED”. Similarly, voice status message 30 can report which and how many print jobs are in queue. In short, with the system and method of the present invention, any information available regarding the functions and features of printer 12 that can be sensed, or any data that is stored within or flowing through printer 12, can be reflected in an audible voice status message 30. Only the limits of the user's imagination limits the number and type of voice status messages 30 that can be reported by printer 12.

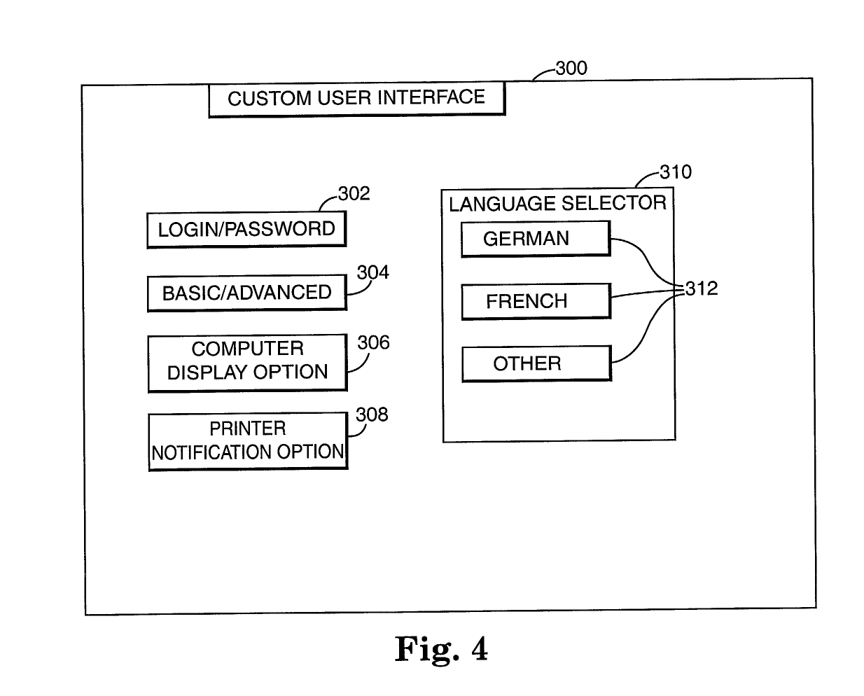

The voice status messaging method and system of the present invention can be further implemented in cooperation with a computing device. In particular, a computing device can be used to select some or all of the features of the method and system of the present invention. For example, as shown in FIG. 4, custom user interface 300 operates in association with an operating system of a computing device associated with printer 12. Custom user interface 300 includes login/password function 302, basic/advanced function 304, computer display option 306, printer notification option 308, and language selector 310 with selectable languages 312.

Login/password function 302 facilitates authorized access to status monitor 56 of printer 12 while basic/advanced function 304 allows selection between basic message set 76 and advanced message set 78 from status message module 72 in memory 52. Computer display option 306 permits the user to cause voice status messages 30 to be displayed on a display screen of a computer associated with printer 12, in addition to or in place of audibly reporting voice status messages 30 through speaker 22. Similarly, printer notification option 308 permits the user to select voice status messages 30 to be printed on paper by printer 12, in addition to or in place of audibly reporting voice status messages 30 through speaker 22.

Finally, language selector 310 permits the user to select a language in which voice status messages 30 will be audibly reported. Language selector 310 includes selectable languages 312 such as English, Spanish, German, French, Russian, etc., all of which are obtained from language selection base 74 of status message module 72 in memory 52. Any desired languages that are not stored in status message module 72 optionally are imported.

Preferably, the user interfaces described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employ a graphical user interface windowing environment which presents the applications or documents in specially delineated areas of the display screen called “windows.” The operating system preferably includes a windows-based dynamic display which allows for the entry or selection of data in dynamic data field locations via an input device such as a keyboard and/or mouse. One preferred operating system is a Windows® brand operating system sold by Microsoft Corporation. However, other operating systems which provide windowing environments may be employed, such as those available from Apple Corporation or IBM. In another embodiment, the operating system does not employ a windowing environment.

A method and system of the present invention for voice status messaging for a printer status includes several advantageous features. First, a printer need not have a bulky or expensive conventional control panel. Second, novice users and users with poor eyesight can be alerted to a printer error and learn what to do about it simply by listening to the voice status messages. These users need not look into a separate user's manual, navigate a cryptic menu in a conventional control panel, and/or learn the meaning of various symbols in a conventional control panel that corresponds to a printer status. Third, the voice status messages can be localized for any cultural, ethnic, and/or geographical environment by selecting from memory the desired language in which the message will be audibly reported. Finally, a printer with voice status messaging in the method and system of the present invention readily allows reasonable accommodations for people with disabilities to comply with the Americans for Disabilities Act (ADA). In particular, by choosing the content of voice status messages 30, including custom message set 79, and selectively adjusting the components of status monitor 56 as necessary, individuals and employers can readily make the reasonable accommodations required under the (ADA).

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A printer comprising:
an imaging mechanism configured for producing images on paper; and
a status message monitor configured for audibly reporting voice messages regarding a status of the printer.

2. The printer of claim 1 wherein the status message monitor comprises:
at least one switch button configured for responding to a status of at least one of a data transmission, a status message, and an operational readiness.

3. The printer of claim 2 wherein the status message monitor comprises:
a status light indicator configured for identifying a status of at least one of a data transmission, a status message, and an operational readiness.

4. The printer of claim 1 and further comprising:
a memory configured for storing the messages.

5. The printer of claim 4 wherein the memory comprises:
a language selector module configured for selecting a language in which the voice status messages will be audibly reported.

6. The printer of claim 1 and further comprising:
at least one of a speaker and an acoustic transducer for emitting the audibly reported messages.

7. The printer of claim 1 wherein the status monitor comprises:
an audible driver configured for selecting and emitting tones and voice status messages.

8. The printer of claim 1 wherein the status monitor comprises:
a visual driver configured for controlling light indicators and optionally for controlling symbol indicators in association with voice status messages reported by the printer.

9. A printer control panel comprising:
an audible status monitor configured for audibly reporting language messages regarding a status of the printer;
a status light indicator configured for identifying a status of at least one function of a printer; and
a keypad configured for responding to the status of the at least one function of a printer.

10. A printer status monitor comprising:
a status message monitor configured for reporting voice messages regarding a status of the printer; and
a control panel configured for visually identifying the status of at least one function of a printer and configured for permitting button switched response to the at least one function of the printer.

11. A printer control panel comprising:
a status message monitor configured for audibly reporting voice messages regarding the status of the printer; and
a voice recognition module configured for receiving voice input to respond to the voice status messages.

12. A method for reporting a printer status comprising:
sensing at least one feature of a printer; and
audibly reporting a status of the at least one feature with a language message.

13. The method of claim 12 wherein audibly reporting a status comprises:
audibly providing a menu of language messages for evaluating the status of the printer.

14. A method of operating a printer comprising:
using the printer to print jobs from a computer; and
audibly reporting at least one language message regarding a status of the printer; and
responding to the audible reported messages.

15. The method of claim 14 wherein responding to the messages further comprises:
refilling the paper tray;
replenishing the ink supply;
cleaning the imaging mechanism;
evaluating the print job; and
retrieving a finished print job;

16. A method of printing documents comprising:
printing documents at a printer; and
reporting voice messages regarding a status of the printer through a speaker of the printer.

17. The method of claim 16 and further comprising:
interacting with the printer by listening to the voice messages and acting on the voice messages to maintain the printer.

18. A computer-readable medium having computer-executable instructions for performing a method of reporting a printer status, the method comprising:
sensing at least one feature of a printer; and
audibly reporting a status of the at least one feature with a voice status message.

19. The medium of claim 18 wherein the method further comprises:
audibly providing a menu of voice status messages for evaluating the status of the printer.

20. A computer-readable medium having computer-executable instructions for performing a method of printing documents, the method comprising:
printing documents at a printer; and
reporting voice messages regarding a status of the printer through a speaker of the printer.

21. A computer-readable medium having computer-executable instructions for performing a method of monitoring a printer status, the method comprising:
reporting voice status messages regarding the status of the printer; and
visually identifying the status of at least one function of a printer and facilitating button switched response to the at least one function of the printer regarding the reported status of the printer.

22. A computer-readable medium having computer-executable instructions for performing a method of voice controlling a printer, the method comprising:
audibly reporting voice status messages regarding the status of the printer; and
receiving voice input from a user to respond to the status messages.
